(19) United States
(12) Patent Application Publication
(10) Pub. No.: US 2008/0238137 A1
(43) Pub. Date: Oct. 2, 2008

(54) Automobile weather strip

(75) Inventors: Kenji Kobayashi, Aichi-ken (JP); Noriyoshi Kawashima, Aichi-ken (JP); Mitsuhiro Takahara, Aichi-ken (JP); Masanori Aritake, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 11/905,390

(22) Filed: Sep. 28, 2007

(30) Foreign Application Priority Data
Sep. 29, 2006 (JP) 2006-267013

(51) Int. Cl. B60J 10/00

(52) U.S. Cl. 296/146.9

(57) ABSTRACT

The weather strip of the invention has an attachment base and a sealing part to be integrally attached to the attachment base for sealing a gap between a vehicle body opening open/close member and a vehicle body opening part. The attachment base has a substantially U-shaped section or a substantially J-shaped section that is formed of a vehicle exterior side wall, a vehicle interior side wall, and a bottom wall, and a sealant member formed from an adhesive material is attached to an inner surface of the attachment base having the substantially U-shaped section or the substantially J-shaped section. The tip of the flange is inserted into an inner part of the sealant member, and the attachment base is attached by an adhesion force of the sealant member.

### BACKGROUND OF THE INVENTION

1. Field of the Invention

The invention relates to an automobile weather strip for sealing a gap between a vehicle body opening open/close member for opening/closing a vehicle body opening of an automobile door, a luggage, a sliding roof, and the like and a vehicle body opening part.

2. Related Art

Though an opening trim weather strip for sealing a gap between a door 2 of an automobile and a vehicle body opening part 6 as shown in FIG. 5 will be described below as an example of the invention, the weather strip is also usable for sealing a vehicle body opening open/close member for opening/closing a vehicle body opening of a back door, a luggage, a sliding roof, and the like.

As shown in FIG. 7, a gap between the door 2 and the vehicle body opening part 6 has heretofore been sealed by a door weather strip 160 attached to a retainer 4 on an outer periphery of a door frame or the like of the door 2, a glass run 150 attached to a channel 3 of an inner periphery of the door frame or the like, and an opening trim weather strip 110 attached to a flange 7 of the vehicle body opening part 6.

The flange 7 is formed of an outer panel 9 defining the vehicle body opening part 6 and a tip of an inner panel 8 or the like, the outer panel 9 and the inner panel 8 being joined by welding or the like.

The glass run 150 houses a tip of a door glass 5 in an inner part having a substantially U-shaped section and formed of a vehicle exterior side wall 151, a bottom wall 152, and a vehicle interior side wall 153 and seals the tip by a vehicle exterior sealing lip 154 and a vehicle interior sealing lip 155 extending from tips of the vehicle exterior side wall 151 and the vehicle interior side wall 153.

The door weather strip 160 attached to the outer periphery of the door 2 is formed of an attachment base 161, a hollow sealing part 164 formed above the attachment base 161 and integrally with the attachment base 161, and a sealing lip 166. The attachment base 161 is fixed to the door frame as being fitted into the retainer 4 provided on the outer periphery of a door frame. The sealing lip 166 is brought into contact with a side edge at the most exterior side of the vehicle body opening part 6 when the door 2 is closed, so that a gap between a tip of the door 2 and the vehicle exterior side edge of the vehicle body opening part 6 is sealed. In this case, the hollow sealing part 164 contacts a projection at a part interior from the part of the vehicle body opening part 6 to which the sealing lip 166 contacts, thereby sealing a gap between the door 2 and the vehicle body opening part 6.

The opening trim weather strip 110 attached to the flange 7 is provided at the opening of the vehicle body to seal the gap between the door 2 and the vehicle body opening part 6 at a part interior from the part at which the door weather strip 160 seals the vehicle body opening part 6. The opening trip weather strip 110 is attached to the flange 7 by an attachment base (trim part) 120 having a substantially U-shaped section, and a hollow sealing part 130 is brought into contact with a projection 2a of the door frame for sealing. The trim part 120 is provided with an insert member 124 such as a metal insert and a holding lip 125 for holding the flange 7, the insert member 124 being embedded into the trim part 120.

As described above, the tip of the outer panel defining the vehicle body opening part 6 and the tip of the inner panel 8 or the like at the vehicle interior side are joined by welding or the like for forming the flange 7, and the outer panel 9 and the inner panel 8 form a cavity outside the flange 7. Noises such as a hissing sound, a tire noise, and a road surface reflected sound are transmitted through the cavity to the entire vehicle body opening part, and a gap is formed in the flange 7 due to unevenness caused by spot welding and unevenness caused by metal plates at the end of the flange 7. The noises leak through the gap to be transmitted to the vehicle interior part.

In order to prevent the noises leaking from the flange 7 as well as rainwater, dust, and noise entering the vehicle interior via the inner part of the trim part 120 of the opening trim weather strip 110 from the outside of the automobile, a technology of inserting a sealing member such as a sponge rubber into the inner part of the trim part 120 has been proposed (see JP-A-09-315152, for example). In this case, the sealing member such as a sponge rubber is only fitted into the inner part of the trim part 120, and it is sometimes impossible to satisfactorily hold the tip of the flange 7 since it takes time to insert the sponge rubber into the depth of the trim part 120 and the sealing part can be detached in some cases.

In order to improve a sealing property, a non-drying sealant member made from a high viscosity material has heretofore been used. For example, the sealant member is enclosed between the attachment base 161 and the retainer 4 or enclosed between the bottom wall 152 and the channel 3 in the glass run 150 in the above-described door weather strip 160. In some of the opening trim weather strips 110, a non-drying sealant member 170 made from a butyl rubber-based high viscosity material is enclosed inside the trim part 120 having the substantially U-shaped section as shown in FIG. 6 (see JP-A-2002-97450, for example).

However, since the sealant member 170 is in the form of a liquid having a high viscosity, handling thereof is troublesome, and, once the trim part 120 is assembled, and, in the case of removing the trim part 120 from the flange 7 after assembly, it is difficult to conduct reassembly since the sealant member 170 sticks to an outer surface of the flange 7 and the trim part 120 as shown in FIG. 7. Also, since the sealant member 170 sticks to the holding lips 125 and 126 at the inner part of the trim part 120 to diminish the force of the holding lips 125 and 126 for holding the flange 7 even when it is possible to conduct the reassembly, there has been a fear for detachment of the opening trim weather strip 110 from the flange 7.

Also, a method of injecting a foamed sealant member into the trim part 120 by using an injection gun has been employed (see JP-A-06-135287, for example).

In the case of the sealing member of the sponge rubber or the like, the sealing member absorbs water to allow the water to enter the inside of the flange 7 from the tip of the flange 7, thereby causing rusting on the flange 7 in some cases. Therefore, some of conventional sealing parts contain an anti-rusting agent (see JP-A-9-25366, for example). However, since the sealing member is depressed when contacting the tip of the flange 7, it has been difficult to satisfactorily enclose the tip, thereby making it difficult to prevent the rusting.

Also, though it is possible to add the anti-rusting agent without considering a content of the anti-rusting agent because the sealing member does not influence on the adhesion force, it is necessary to consider a reduction in adhesion force in the case of adding the anti-rusting agent to the sealant member that influences on the adhesion force.

### SUMMARY OF THE INVENTION

An object of the invention is to provide an automobile weather strip capable of holding the weather strip at the flange and enabling easy reassembly.

(1) In order to attain the above object, the first aspect of the invention provides an automobile weather strip for sealing a gap between a vehicle body opening open/close member of an automobile and a vehicle body opening part of the automobile, which comprises

an attachment base to be attached to a flange provided on either one of the vehicle body opening open/close member or the vehicle body opening part and a sealing part provided integrally with the attachment base and brought into contact with the vehicle body opening open/close member or the vehicle body opening part to seal a gap between the vehicle body opening open/close member and the vehicle body opening part, wherein

the attachment base has a substantially U-shaped section or a substantially J-shaped section formed of a vehicle exterior side wall, a vehicle interior side wall, and a bottom wall and is provided with a sealant member made from an adhesive material and attached to an inner surface of the attachment base having the substantially U-shaped section or the substantially J-shaped section so that the attachment base is attached by inserting a tip of the flange into an inner part of the sealant member and by an adhesion force of the sealant member.

According to the first aspect of the invention, the weather strip has an attachment base (trim part) to be attached to a flange provided on either one of the vehicle body opening open/close member or the vehicle body opening part and a sealing part provided integrally with the attachment base and brought into contact with the vehicle body opening open/close member or the vehicle body opening part to seal a gap between the vehicle body opening open/close member and the vehicle body opening part. Therefore, by attaching the attachment base to an outer periphery of the vehicle body opening open/close member or the vehicle body opening part, it is possible to seal the gap between the vehicle body opening open/close member and the vehicle body opening part due to contact between the sealing part and the vehicle body opening part or the vehicle body opening open/close member when the vehicle body opening open/close member is closed.

The attachment base (trim part) has the substantially U-shaped section or the substantially J-shaped section which is formed of the vehicle exterior side wall, vehicle interior side wall, and the bottom wall. Accordingly, it is possible to insert the flange formed on the outer periphery of the vehicle body opening open/close member or a vehicle body door opening rim into the inner part of the attachment base as well as to insert at least the tip of the flange to hold the flange by the viscosity of the sealant. Therefore, it is possible to prevent detachment of the flange, and it is possible to mount the automobile weather strip easily when a thickness of the flange is changed.

Further, in the case of removing the weather strip after assembly and then reassembling the weather strip, since the sealant member does not adhere to the tip of the flange and an outer part of the attachment base, the flange is held firmly by the viscosity. Since the sealant member does not protrude to the outside, good appearance is achieved. Further, since it is possible to hold the flange by enclosing the tip of the flange inside the sealant member, the flange hardly or never comes off from the sealant member, thereby preventing entrance of noises from the flange to the inside of the automobile.

(2) The second aspect of the invention provides the automobile weather strip according to the first aspect of the invention, wherein a holding lip for holding the flange by contacting side surfaces of the flange is formed on inner surfaces of the vehicle exterior side wall and the vehicle interior side wall of the attachment base, and an insert member is embedded into the attachment base, so that the attachment base is attached to the flange by the adhesion force of the sealant and a holding force of the holding lip.

According to the second aspect of the invention, since the holding lip for holding the flange by contacting the side surfaces of the flange is formed on the inner surfaces of the vehicle exterior side wall and the vehicle interior side wall of the attachment base, a force of holding the flange is strong, thereby reliably sealing the gap between the flange and the attachment base.

The automobile weather strip is characterized by embedding the insert member into the inner part of the attachment base and attaching the attachment base to the flange by the adhesion force and the holding force of the holding lip. Accordingly, it is possible to improve the flange holding force by the insert member as well as to mount the attachment base at a corner part by bending the attachment base flexibly along a shape of the outer periphery of the automobile door or the vehicle body door opening rim.

(3) The third aspect of the invention provides the automobile weather strip according to the first aspect of the invention, wherein the inner surface of the attachment base is a flat surface; the sealant member made from the adhesive material is attached at least to inner surfaces of the vehicle exterior side wall and the bottom wall; and the attachment base is attached to the flange by the adhesion force of the sealant member.

Therefore, it is possible to reduce a weight of the automobile weather strip as well as to easily insert the attachment base into the flange without deforming the holding lip and without changing the insertion force of the attachment base in attaching the attachment base to the flange even when the thickness of the flange is changed. Since the sealant member firmly holds the tip of the flange, the attachment base never comes off from the flange even when there is no insert member.

(4) The fourth aspect of the invention provides the automobile weather strip according to the first aspect of the invention, wherein the attachment base is made from a polymer material such as a rubber and a resin without insert member.

Therefore, it is possible to reduce the weight of the automobile weather strip as well as to easily produce the weather strip. Since the sealant member firmly holds the tip of the flange in the same manner as described above, the attachment base never comes off from the flange when there is no insert member.

(5) The fifth aspect of the invention provides the automobile weather strip according to the first aspect of the invention, wherein the sealant member has a glass transition temperature of −10° C. or less, and the adhesion force of the sealant member is 15 to 40 N.

According to the fifth aspect of the invention, it is possible to hold the flange with a sufficient adhesion force.

(6) The sixth aspect of the invention provides the automobile weather strip according to the first aspect of the invention, wherein the vehicle body opening open/close member is a door, and the weather strip is an opening trim weather strip.

According to the sixth aspect of the invention, it is possible to reliably hold the opening trim weather strip at the flange of the vehicle body opening part as well as to reliably prevent noises from entering to the inside of the automobile from a clearance of the flange.

In the automobile weather strip according to the invention, the sealant member formed from an adhesive material is attached to the inner part of the attachment base, the tip of the flange is inserted into the inner part of the sealant member, and the attachment base is attached to the flange by the adhesion force of the sealant member. Therefore, it is possible to firmly hold the flange by the highly adhesive sealant member as well as to prevent sticking of the sealant member to the tip of the flange and the inner part of the attachment base in reassembly. Consequently, in the case where the holding lip is formed in the attachment base, the force of the holding lip for holding the flange is strong since the sealant member does not stick to the tip of the holding lip, and the sealant member does not protrude outside. Further, the flange is hardly or never comes off from the sealant member, and the sealant member encloses the tip of the flange, thereby preventing entrance of noises from the flange to the inside of the automobile.

Further, according to the invention, it is possible to firmly hold the flange since the sealant member has an adhesion property due to its glass transition temperature of −10° C. or less and a satisfactory adhesion force to easily adhere to the flange and is in close contact with the tip of the flange by perfectly enclosing the tip of the flange inserted into the inner part of the sealant member provided on the inner surface of the attachment base. Further, since the tip of the flange is perfectly inserted into the inner part of the sealant member, the anti-rusting agent contained in the sealant member perfectly covers the tip part of the flange to prevent rusting at the tip of the flange.

### BRIEF DESCRIPTION OF THE DRAWINGS

FIG. 1 is a sectional view showing a state in which an opening trim weather strip according to the first embodiment is attached to a vehicle body opening part of a part along a line A-A of FIG. 6.

FIG. 2 is a sectional view showing a state in which an opening trim weather strip according to the second embodiment is attached to a vehicle body opening part of a part along a line A-A of FIG. 6.

FIG. 3 is a sectional view showing a state in which an opening trim weather strip according to the third embodiment is attached to a vehicle body opening part of a part along a line A-A of FIG. 6.

FIG. 4 is a sectional view showing a state in which an opening trim weather strip according to the fourth embodiment is attached to a vehicle body opening part of a part along a line A-A of FIG. 6.

FIG. 5 is a perspective view showing a side surface of the automobile.

FIG. 6 is a front view showing the opening trim weather strip according to one embodiment of the invention.

FIG. 7 is a sectional view showing a sealing structure around a door when a conventional opening trim weather strip is attached to an opening rim of an automobile.

FIG. 8 is a sectional view showing a part of another conventional opening trim weather strip that is attached to an opening rim of an automobile.

FIG. 9 is a sectional view showing a part of another conventional opening trim weather strip that is detached from an opening rim of an automobile.

### DETAILED DESCRIPTION OF THE PREFERRED EMBODIMENTS

An opening trim weather strip 10 will be described based on embodiments of the invention. The invention is applicable to a weather strip to be used for a vehicle body opening and a vehicle body opening open/close member for closing the opening, such as a door weather strip, a luggage weather strip, and a back door weather strip, in addition to the opening trim weather strip 10.

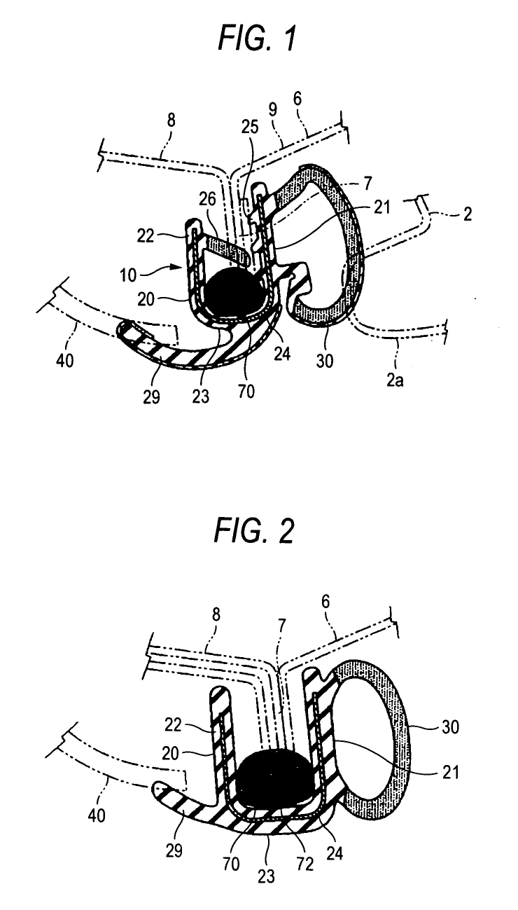

The invention will be described based on FIGS. 1 to 6.

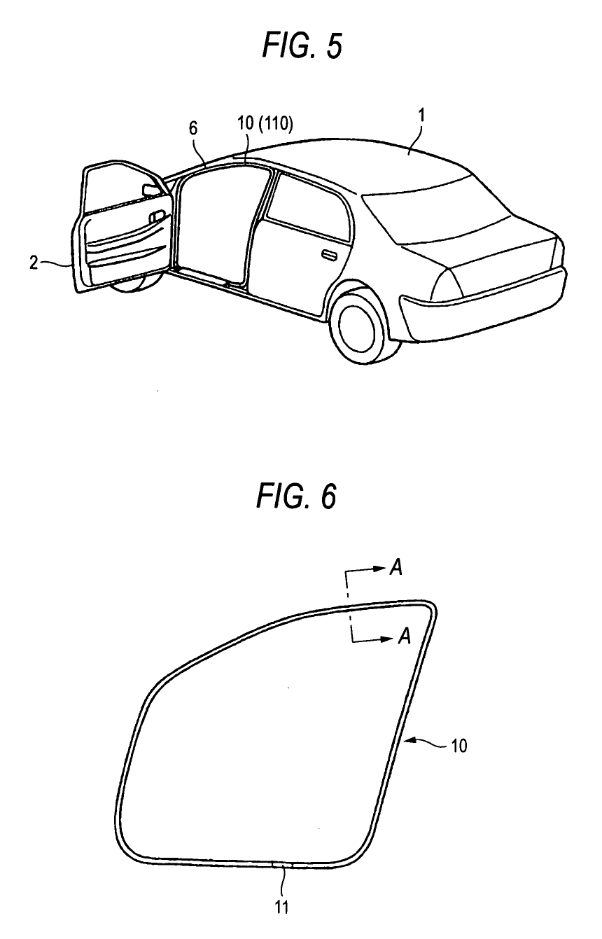

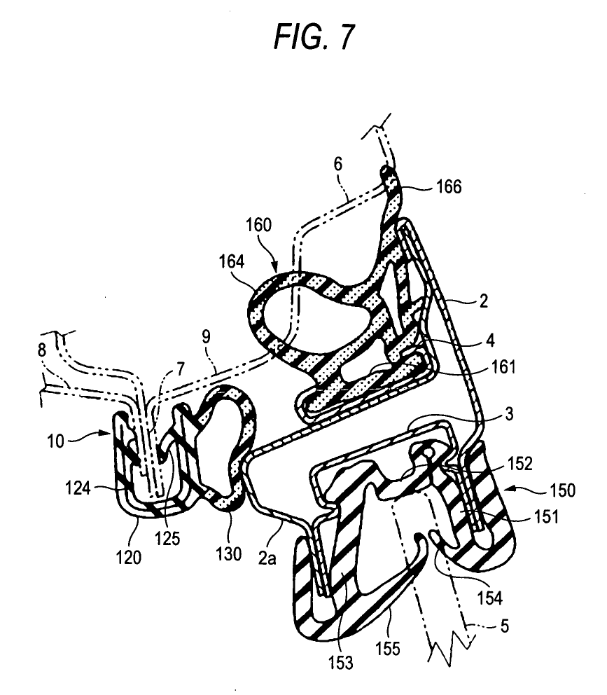

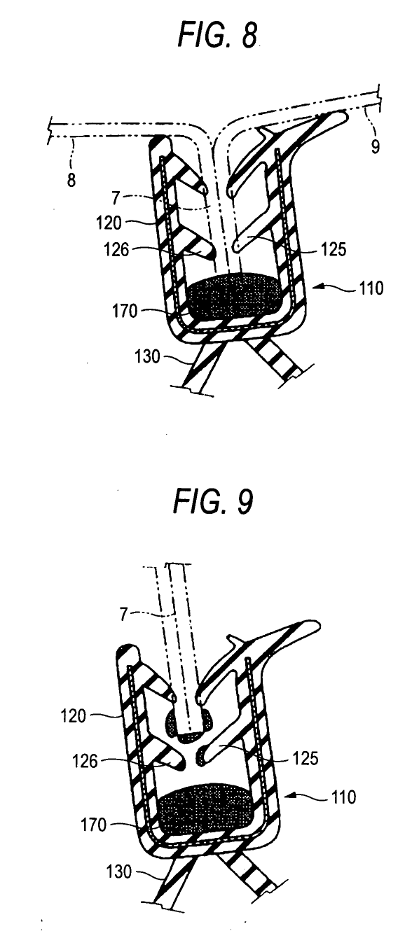

FIG. 1 is a sectional view showing a part taken along a line A-A of FIG. 6 wherein the opening trim weather strip 10 is attached to a vehicle body opening part 6 in FIG. 5. Shown in FIGS. 2 to 4 are opening trim weather strips 10 according to other embodiments of the invention. Each of FIGS. 2 to 4 is a sectional view showing the part taken along the line A-A of FIG. 6 wherein the opening trim weather strip 10 is attached to a vehicle body opening part 6 in FIG. 5.

FIG. 5 is a perspective view showing a state of attachment of the opening trim weather strip 10 to the vehicle body opening part 6 wherein a door 2 of an automobile is opened. FIG. 6 is a front view showing the opening trim weather strip 10 to be attached to the vehicle body opening part 6.

As shown in FIG. 5, a vehicle body 1 of an automobile has a vehicle body opening and the vehicle body opening is opened/closed by the door 2 that is an open/close member of the vehicle body opening. A periphery of the vehicle body opening forms the vehicle body opening part 6, and a flange 7 (see FIGS. 1 to 4) is formed on the vehicle body opening part 6 by joining and welding a tip of an outer panel 9 defining the vehicle body opening part 6 of the vehicle body 1 and a tip of an inner panel 8. The opening trim weather strip 10 is attached to the flange 7 for sealing a gap between the vehicle body opening part 6 and the door 2.

The opening trim weather strip 10 is molded linearly by an extrusion molding. The linear opening trim weather strip 10 is attached to the flange 7 along a shape of the vehicle body opening part 6 to be in the form of a ring as shown in FIG. 6. The attachment to the flange 7 is performed from one end of the opening trim weather strip 10, and the end is joined to the other end when the attachment is finished. The ends may be joined by employing mold-connection so that the ends are connected at a connection part 11 to form the ring-like shape.

Also, the ends of the opening rim weather strip 10 may be joined in advance of the attachment to form the ring-like shape.

Next, a sectional shape of the opening trim weather strip 10 according to the first embodiment will be described based on FIG. 1.

The opening trim weather strip 10 has an attachment part (trim part) 20 to be attached to the flange 7 and having a substantially U-shaped section and a sealing part (hollow sealing part) 30 that contacts a projection 2a of a door frame of the door 2 to seal a gap between the door 2 and the vehicle body opening part 6.

The trim part 20 has the substantially U-shaped section formed of a vehicle exterior side wall 21, a vehicle interior side wall 22, and a bottom wall 23, and an insert member 24 is embedded into the trim part 20 in this embodiment in order to reinforce a force of the trim part 20 for holding the flange 7.

The insert member 24 is formed from a metal plate, a metal wire, or a hard synthetic resin. In the case of using the metal plate or the hard synthetic resin, a multiple of strip pieces are aligned along a widthwise direction and in parallel to one another and connected in a longitudinal direction to be in the form of a ladder or a fish bone or connected in the form of a zigzag line. In order to increase flexibility of the trim part 20, connection parts of the strip pieces may be separated one by one or by a plural number of the strip pieces after embedding the insert member 24. When the strip pieces are connected in the form of a zigzag line, such insert member 24 has a stretching property in the longitudinal direction and has flexibility.

As the insert member 24 made from the metal wire, a so-called wire carrier type which is obtained by bending a metal wire in the form of a zigzag line and holding the metal wire with a plurality of threads along a longitudinal direction is used.

On an inner surface of the trim part 20, a plurality of vehicle exterior holding lip 25 and a vehicle exterior holding lip 26 are extended from the vehicle exterior side wall 21 and the vehicle interior side wall 22 in an oblique direction toward the bottom wall 23. When the flange 7 of the vehicle body opening part 6 is inserted into an inner part of the substantially U-shaped section of the trim part 20, the vehicle exterior holding lip 25 and the vehicle interior holding lip 26 holds side surfaces of the flange 7, so that the opening trim weather strip 10 is held by the flange 7.

In this embodiment, each of the plural vehicle exterior lips 25 is short, and the vehicle interior holding lip 26 is long. A thickness of the flange 7 is changed due to the number of the metal plates that differs depending on parts of the vehicle body opening part 6 for forming the flange 7. The vehicle interior holding lip 26 is bent flexibly in accordance with the change in thickness of the flange 7 to reliably hold the flange 7 irrelevant from the change in thickness.

A cover lip 29 is extended from a continuous part of the bottom wall 23 and the vehicle interior side wall 22 of the trim part 20 toward the vehicle interior side to cover a tip of a garnish 40 mounted inside the automobile, thereby improving the appearance.

As shown in FIG. 1, a sealant member 70 is inserted into the inner part of the trim part 20. For the sealant member 70, an adhesive material is used as a base material, and a foaming agent, an anti-rusting agent, and the like are mixed with the base material as required. As the adhesive agent, those having a glass transition temperature of −10° C. or less are preferred. When the glass transition temperature is −10° C. or less, the sealant member 70 has a sufficient adhesion force to firmly hold the flange 7. The sufficient adhesion force means that a value measured by the test method described later in this specification is 15 N or more, and, in view of the re-attachment of the trim part 20, the sufficient adhesion force may preferably be 15 to 40 N.

In order to prevent rusting at the tip of the flange to which the weather strip is to be attached, an anti-rusting agent is added to the base material of the adhesive agent.

As the anti-rusting agent, one or more species selected from a nitrite salt, an amine-based inorganic compound, and a phosphoric acid-based compound maybe used. An amount of the anti-rusting agent to be added to the base material may preferably be 1 to 5 wt % with respect to the adhesive agent. It is difficult to achieve a satisfactory anti-rusting effect when the amount is less than 1 wt %, and, when the amount exceeds 5 wt %, there is a fear for a reduction in physical properties (reduction in adhesion force) of the base material and the cost is undesirably increased.

As the nitrite salt, at least one of sodium nitrite, potassium nitrite, calcium nitrite, magnesium nitrite, and the like may be used.

As the amine-based inorganic compound, an amine nitrite salt, an amine phosphate salt, an amine carbonate salt, and the like may be used.

As the phosphoric acid-based compound, a phosphate compound such as zinc phosphate, calcium phosphate, zinc phosphite, potassium phosphite, and calcium phosphite; a polyphosphate-based compound such as aluminum dihydrogentripolyphosphate; an amine phosphate salt, and the like may be used.

By mixing such anti-rusting agent with the sealant member 70, it is possible to obtain the sealant member 70 having flexibility, easily fitting to the flange, and having an adhesion force of 15 to 40 N since the glass transition temperature of the sealant member 70 is −10° C. or less. Therefore, in the case of inserting the tip of the flange 7 into the inner part of the sealant member 70 provided on the inner surface of the trim part 20 having the substantially U-shaped section or the substantially J-shaped section, the sealant member 70 perfectly encloses the tip of the flange 7 to be in close contact with the tip of the flange 7, thereby firmly holding the flange 7. Since the sealant member 70 is the adhesive agent, the tip of the flange 7 hardly or never comes off from the sealant member 70. Also, it is possible to prevent entrance of noises from the flange 7 to the inside of the automobile.

Further, since the tip of the flange 7 is perfectly inserted into the inner part of the sealant member 70, the anti-rusting agent contained in the sealant member 70 perfectly covers the tip part of the flange 7 to prevent the flange 7 from rusting.

Since the anti-rusting agent is contained in the amount of 1 to 5 wt % of the sealant member 70, the adhesion force of 15 to 40 N of the sealant member 70 will not be reduced by the anti-rusting agent.

The sealant member is easily deformed, the tip of the flange can penetrate into the sealant member with small force, since the sealant member is the adhesive agent which is in the foamed state. Accordingly, it is easy to attach the weather strip to the flange. The sealant member has the strong force for holding the flange by perfectly enclosing the tip of the flange inside thereof after the weather strip attachment and by closely contacting the tip of the flange.

Since the sealant member is formed from the adhesive agent, the sealant member does not stick to the tip of the flange or the outer part of the attachment base when detaching the attachment base. The sealant member does not protrude outside to keep the good appearance.

In the invention, the sealant member may be foamed by physical foaming or chemical foaming.

When the sealant member is foamed by physical foaming or chemical foaming, it is possible to control a foamed state such as a foaming ratio as well as to impart flexibility required for the sealant member.

In the invention, the physical foaming of the sealant member maybe performed by mixing a gas-filled balloon with the base material or by mixing a pressurized gas with the base material in a cylinder under a pressurized state.

When a gas-filled balloon is mixed, uniform bubbles are formed to make it easy to obtain independent bubbles, thereby increasing a sealing property. In the case of mixing a pressurized gas in a cylinder under a pressurized state, since it is possible to produce a foamed body without using any foaming agent, this method is free from foaming residue and does not require heating step for foaming.

The chemical foaming of the sealant member may be performed by using a foaming agent obtained by mixing one or more of an azo compound, a nitroso compound, a hydrazine compound, and a sodium hydrogen carbonate-based compound.

When a foaming agent obtained by mixing one or more of an azo compound, a nitroso compound, a hydrazine compound, and a sodium hydrogen carbonate-based compound is used, it is possible to achieve foaming only by mixing a predetermined amount of the foaming agent with the base material and heating, to achieve a large foaming amount, to easily control the foaming amount, as well as to easily obtain a foamed body.

In the invention, the chemical foaming of the sealant member may be performed by using a foaming agent and a foaming auxiliary agent.

When the chemical foaming of the sealant member is performed by using a foaming agent and a foaming auxiliary agent, the foaming agent is perfectly decomposed to make it possible to obtain a uniform foamed body as well as to adjust a foaming temperature.

In the invention, the sealant member may be in a foamed state and formed from an adhesive agent containing an anti-rusting agent.

When the sealant member is in a foamed state and formed from an adhesive agent containing an anti-rusting agent, the sealant member is soft enough to allow the tip of the flange to be perfectly inserted into the inner part of the sealant member, thereby perfectly enclosing the tip of the flange. Also, the anti-rusting agent contained in the sealant member perfectly covers the tip of the flange to prevent rusting of the flange.

In the invention, the base material of the sealant member may be an emulsion of a copolymer of acrylonitrile and ester acrylate; and the foaming agent may be dinitrosopentamethylenetetramine; and the foaming auxiliary agent may be urea.

When the sealant member is an emulsion of a copolymer of acrylonitrile and ester acrylate, it is possible to copolymerize monomers varied in characteristics to obtain sealant members varied in adhesion properties. When dinitrosopentamethylenetetramine is used as the foaming agent and urea is used as the foaming auxiliary agent, it is possible to easily adjust a decomposition temperature as well as to achieve a satisfactory amount of foaming with the use of a small amount of the foaming agent due to the increase in generated amount of decomposed gas.

Examples of a base material for the adhesive agent include a synthetic resin-based base material such as an acryl-based base material, a silicone resin-based base material, and an ethylene-vinyl acetate copolymer (EVA)-based base material and a rubber-based base material such as a natural rubber-based base material, an isoprene rubber-based base material, and a styrene-isoprene rubber-based base material.

The sealant member contains a softening agent, an adhesion property imparting agent, a filler, and an anti-aging agent in addition to the above polymer used as the base. A foaming agent for imparting resiliency and an anti-rusting agent for preventing the flange from rusting may be further contained.

Examples of the acryl-based based material which is the synthetic resin-based adhesive agent include ester polyacrylate, an ester polyacrylate copolymer, and the like.

The silicone-resin based adhesive agent is formed of a silicone rubber, a silicone resin, and an organic solvent and excellent in heat resistance and an adhesion force at high/low temperatures.

The ethylene-vinyl acetate copolymer (EVA)-based adhesive agent mainly contains a resin obtained by copolymerizing ethylene vinyl alcohol and vinyl acetate.

Among the above-described synthetic resin-based adhesive agents, the acryl-based adhesive agents and the silicone resin-based adhesive agents are preferred as compared to the EVA-based adhesive agent in view of odor, and the acryl-based adhesive agents are preferred as compared to the silicone resin-based adhesive agents in view of a cost.

Examples of the acryl-based adhesive agent among the synthetic resin-based adhesive agents include ester polyacrylate, an ester polyacrylate copolymer, and the like.

The silicone resin-based adhesive agent is formed from a silicone rubber, a silicone resin, and an organic solvent and excellent in heat resistance and adhesion force at high and low temperatures.

The ethylene-vinyl acetate copolymer (EVA)-based adhesive agent is an adhesive agent mainly containing a resin obtained by copolymerizing ethylene vinyl alcohol and vinyl acetate.

The natural rubber-based adhesive agent, which is the rubber-based adhesive agent, mainly contains a natural rubber. The isoprene rubber-based adhesive agent mainly contains an isoprene rubber. The styrene-isoprene rubber-based adhesive agent is a block copolymer of styrene and isoprene. Also, it is possible to use a block copolymer of styrene and butylene.

As the rubber-based adhesive agent, it is preferable to use those mainly containing the natural rubber, and the synthetic resin-based adhesive agents are preferred as compared to the rubber-based adhesive agents in view of handling easiness.

These adhesive agents may be used as a hot-melt type or an emulsion type.

The hot-melt type adhesive agent exhibits an adhesion force by melt-solidification and does not contain volatile component such as an organic solvent. Since a work environment of the hot-melt type adhesive agent is good, it is possible to achieve a rapid adhesion, high productivity of working, and handling easiness.

Examples of the hot-melt type adhesive agent include a synthetic resin-based ethylene-vinyl acetate copolymer (EVA), a rubber-based styrene-isoprene rubber-styrene copolymer, and the like.

The emulsion type adhesive agent is in the form of an emulsion by dispersion of colloid particles or fine particles larger than the colloid particles of a resin or a rubber into a solvent. In the case where water is used as the solvent, the emulsion type adhesive agent is free from a volatile component such as an organic solvent and achieves a good work environment like the hot-melt type adhesive agent. Further, it is possible to use generally used coating devices for the emulsion type adhesive agents, and handling of the emulsion type adhesive agents is easier than the hot-melt adhesive agents.

Examples of the emulsion type adhesive agents include a synthetic resin-based ethylene-vinyl acetate copolymer (EVA), an ester acrylate resin, a styrene/ester acrylate resin, silicone/ester acrylate hybrid resin, and the like, and examples of the rubber-based adhesive agents include a natural rubber, styrene-isoprene rubber-styrene copolymer, and the like.

More specifically, as the component of the acryl-based adhesive agent, a copolymer formed of a main monomer and a sub monomer maybe used. It is possible to obtain a base material having required properties for the sealant member by appropriately combining the main monomer and the sub monomer. As the main monomer, acrylonitrile, butyl acrylate, 2-ethylhexyl acrylate, isooctyl acrylate, octyl acrylate, isononyl acrylate, decyl acrylate, decyl methacrylate, dodecyl acrylate, dodecyl methacrylate, and the like may be used.

As the sub monomer, ester acrylate, acrylic acid, methacrylic acid, vinyl acetate, methyl acrylate, methyl methacrylate, and the like may be used.

For example, as the base material for the emulsion type acryl-based adhesive agent, a copolymer of acrylonitrile and ester acrylate, polyalkyleneglycol(meth)acrylate, a sulfoalkyl(meth)acrylate salt, alkyl-substituted (meth)acrylamide, and the like may be used. In the case of using the copolymer of acrylonitrile and ester acrylate, an emulsion containing 55% of the synthetic resin in water may be used.

As a base material for the hot-melt type acryl-based adhesive agent, a block copolymer of an ester (meth)acrylate polymer and a vinyl-based polymer, a copolymer containing ester(meth)acrylate and unsaturated carboxylic acid, and the like may be used.

As a base material for the silicon resin-based adhesive agent, a mixture of a silicone rubber which is a long chain polymer of polymethylmethylsiloxane and a silicone resin (MQ resin) having a three-dimensional structure may be used. Since silicone in the silicone resin-based adhesive agent has remarkably high heat stability, the silicone resin-based adhesive agent is excellent in heat resistance, cold resistance, and water resistance and usable under a wide range of temperatures.

The sealant member contains a softening agent, an adhesion property imparting agent, a filler, and an anti-aging agent in addition to the polymer used as the base. The sealant member may further contain a foaming agent for achieving elasticity and an anti-rusting agent for preventing the flange from rusting.

The softening agent is compatible with the polymer of the base material and capable of being dispersed in the system to relieve linkage for causing plastic flow or imparts a lubricating property to soften and wet a substance to be adhered.

As the softening agent, liquid polybutene, a mineral oil, liquid polyisobutylene, liquid ester polyacrylate, and the like may be used.

The adhesion property imparting agent imparts an adhesion force to the sealant member and improves the adhesion force by reducing a coagulating force, an apparent viscosity, and a critical surface tension. Examples of the adhesion property imparting agent include login, a login derivative, a polyterpene resin, a terpenphenol resin, a petroleum resin, and the like.

It is unnecessary to add the adhesion property imparting agent in the case of a copolymer of acrylonitrile and ester acrylate is used as a base material for the emulsion type acryl-based adhesive agent as described above in which the glass transition temperature of −30° C. and the sufficient adhesion force such as 28 N when double-foamed are achieved.

The filler is used for the purposes of imparting heat resistance and electrical characteristics, coloring, a reduction in cost due to an increase in amount, and the like. The filler is required to be easily and uniformly dispersed, suppressed in deterioration in physical and chemical characteristics, and inexpensive, and examples of the filler include zinc flower, titanium white, calcium carbonate, clay, and the like.

The anti-aging agent prevents deterioration of the base material of the sealant member due to oxidation caused by ozone, heat, and light, and it is possible to use anti-aging agents used for general rubber products. There are two types of anti-aging agents, namely, phenol-based anti-aging agents and amine-based anti-aging agents, and the anti-aging agents prevent the oxidation of the base material by reacting with radicals generated in the base material.

The sealant member 70 formed from the adhesive agent is inserted as being brought into close contact with the bottom wall 23 at the inner surface of the trim part 20 as shown in FIG. 1, and the tip of the flange 7 is inserted into the sealant member 70, so that the sealant member 70 holds the tip of the flange 7 and attaches the trim part 20 to the flange 7 by the adhesion force.

In this embodiment, the side surfaces of the flange 7 are held by the vehicle exterior holding lips 25 and the vehicle interior holding lip 26. Therefore, even when the thickness of the flange 7 is changed, the vehicle interior holding lip 26 is easily deformed to fit to the change for holding the flange 7, so that the vehicle interior holding lip 26 firmly holds the flange 7 in cooperation with the adhesion force of the sealant member 70. Thus, it is possible to reliably seal the gap between the flange 7 and the trim part 20.

Also, since the tip of the flange 7 is held by the highly adhesive sealant member 70, the sealant member 70 stays as one piece without being split off and without sticking to the tip of the flange 7, the vehicle interior holding lip 26 of the trim part 20, or the like in the case where the opening trim weather strip 10 is detached from the flange 7 for repair or the like.

Further, in the case of reassembly, the sealant member 70 stays as one piece and adheres to the flange 7 and has the strong force for reliably holding the tip of the flange 7 in the inner part of the sealant member 70. Since the sealant member 70 does not protrude outside, good appearance is achieved. Also, since the sealant member 70 encloses the tip of the flange 7, it is possible to prevent entrance of noises from the flange 7 to the inside of the automobile.

The sealant member 70 of the first embodiment is obtainable by using the synthetic resin-based acryl-based adhesive agent made from the copolymer of acrylonitrile and ester acrylate. A glass transition temperature of the acryl-based sealant member is −30° C., and an adhesion force of the sealant member is 35N which is measured by inserting a copper plate having a thickness of 3 mm and a width of 50 mm into the sealant member 70 at a force of 30 N and then pulling up the sealant member 70 vertically to detect a force at which the copper plate falls off from the sealant member 70.

A double foamed material of the sealant member 70 has an adhesion force of 28 N.

It is unnecessary to add the adhesion property imparting agent in the case of the first embodiment, so that the glass transition temperature of −30° C. and the sufficient adhesion force such as 28 N when double-foamed are achieved.

In the opening trim weather strip 10, the hollow sealing part 30 is integrally formed with the trim part 20. In this embodiment, the hollow sealing part 30 is integrally formed with an outer surface of the vehicle exterior side wall 21. The hollow sealing part 30 contacts the projection 2a of the door 2 when the door 2 is closed, thereby sealing the gap between the door 2 and the vehicle body opening part 6. A sealing lip in the form of lips may be provided in place of the hollow sealing part 30. It is possible to obtain products having good weather resistance by forming the hollow sealing part 30 from a sponge material obtainable from an EPDM rubber or an olefin-based thermoplastic elastomer and forming the trim part 20 from a slid material or a microfoamed material obtainable from an EPDM rubber or an olefin-based thermoplastic elastomer. In this case, since the opening trim weather strip 10 as a whole is olefin-based, it is possible to pulverize the opening trim weather strip 10 as it is to be recycled.

The sealant member 70 formed from the adhesive agent containing the copolymer of acrylonitrile and ester acrylate and 1 to 5 wt % of the anti-rusting agent is inserted into the bottom wall 23 at the inner surface of the trim part 20 as being in close contact with the bottom wall 23 as show in FIG. 1, and the tip of the flange 7 is inserted into the inner part of the sealant member 70. Thus, the sealant member 70 holds the tip of the flange 7, and the anti-rusting agent in the sealant member 70 forms a coating on the tip of the flange 7 to prevent rusting.

In this embodiment, the side surfaces of the flange 7 are held by the plural vehicle exterior holding lips 25 and the vehicle interior holding lip 26. Therefore, since the vehicle interior holding lip 26 is deformed to hold the flange 7 even when the thickness of the flange 7 is changed, the force for holding the flange 7 is strong, and it is possible to reliably seal the gap between the flange 7 and the trim part 20.

As described in the foregoing, the base material of the adhesive agent of the sealant member 70 is foamed. The foaming of the sealant member 70 is performed by physical foaming, chemical foaming, or a combination thereof.

The physical foaming of the base material of the sealant member 70 is performed by mixing a gas-filled balloon with the base material or by mixing a pressurized gas with the base material in a cylinder under a pressurized state.

The gas-filled balloon is a microcapsule made from a polymer material and enclosing a volatile liquid or a sublimation solid. Examples of the volatile liquid or the sublimation solid include hydrogen carbonate, halogenated hydrogen carbonate, alcohol, ether, ketone, a sublimation compound, and the like. When mixing the gas-filled balloon, bubbles become uniform to make it easy to obtain independent bubbles, thereby achieving a good sealing property.

In order to mix a pressurized gas in a cylinder under a pressurized state, the base material of the sealant member 70 is introduced into the cylinder of an extrusion molding machine to melt the base material and achieving the pressurized state. After that, the base material is foamed by introducing nitrogen, a carbonate gas, air, and the like to the cylinder. In this case, since it is possible to produce a foamed body without using any foaming agent, this method is free from foaming residue and a reduction in physical properties of the base material and does not require heating step for foaming.

For the chemical foaming of the base material of the sealant member 70, a foaming agent obtained by mixing one or more of an azo compound, a nitroso compound, a hydrazine compound, and a sodium hydrogen carbonate-based compound may be used.

As the azo compound foaming agent, azodicarbon amide (ADCA), barium azodicarboxylate, azobisisobutylnitrile, or the like may be used.

As the nitroso compound foaming agent, dinitrosopentamethylenetetramine (DPT) or the like may be used.

As the hydrazine derivative foaming agent, p,p′-oxybisbenzenesulfonyl hydrazide (OBSH), toluenesulfonyl hydrazide, or the like may be used.

As the sodium hydrogen carbonate-based compound foaming agent, sodium hydrogen carbonate, ammonium carbonate or the like may be used.

A foaming auxiliary agent may be used in addition to the foaming agent. As the foaming auxiliary agent, urea may be used for example. With the use of the foaming auxiliary agent, the foaming agent is perfectly decomposed to obtain a uniform foamed body as well as to adjust a foaming temperature.

As described in the foregoing, by the chemical foaming, it is possible to achieve foaming only by mixing the foaming agent with the base material and heating, and it is possible to achieve a large foaming amount, to easily control the foaming amount, and to easily obtain the foamed body.

The foaming agent is used in an amount of 1 to 5 wt % with respect to the base material of the sealant member 70. When the amount of the foaming agent is less than 1 wt %, the foaming amount of the base material is insufficient to reduce flexibility of the sealant member 70, thereby requiring a larger force for inserting the tip of the flange 7 into the sealant member 70 and making the assembly work difficult. When the amount exceeds 5 wt %, the foaming amount is increased too much to reduce the strength and the adhesion force of the base material, thereby making it difficult to firmly hold the flange 7.

A preferred foaming amount is a double foaming wherein a volume is increased twice as much as the original volume in view of the strength and adhesion force of the base material.

An anti-rusting agent may be added to the base material of the adhesive agent in order to prevent rusting of the tip of the flange 7 to which the weather strip is to be attached. In this case, the foamed sealant member 70 is increased in flexibility and reliably encloses the tip of the flange 7 and closely contacts the flange 7. The anti-rusting agent contained in the sealant member 70 reliably forms a film on the tip of the flange 7.

As the anti-rusting agent, one or more selected from a salt nitrite, amine-based inorganic compound, and a phosphoric acid-based compound may be used. An amount of the anti-rusting agent to be added may preferably be 1 to 5 wt % of the adhesive agent. A satisfactory anti-rusting effect is not achieved when the amount is less than 1 wt %, and, when the amount exceeds 5 wt %, there is a fear for a reduction in physical properties (reduction in adhesion force) of the base material and the cost is undesirably increased.

Hereinafter, a second embodiment will be described based on FIG. 2. The second embodiment is the same as the first embodiment except for omission of the vehicle exterior holding lips 25 and the vehicle interior holding lip 26 that are disposed on the inner surface of the trim part 20. Therefore, the different part will be mainly described, and the description for the common parts is omitted.

In the second embodiment, the trim part 20 has a substantially U-shaped section, and the sealant member 70 is provided at the bottom 23 of the inner part of the trim part 20. The vehicle exterior holding lips 25 and the vehicle interior holding lip 26 are not formed on the vehicle exterior side wall 21 and the vehicle interior side wall 22. Therefore, when attaching the opening trim weather strip 10 to the flange 7, the flange 7 is directly inserted into the sealant member 70 without deforming the vehicle interior holding lip 26. Also, it is possible to reduce a weight of the opening trim weather strip 10 as well as to enable easy attachment of the trim part 20 due to the reduced insertion force for attaching the flange 7 to the inside of the trim part 20.

In this case, because the adhesion force of the sealant member 70 is strong (35 N) to firmly hold the tip of the flange 7, the flange 7 never comes off from the trim part 20 without the vehicle exterior holding lips 2.5 and the vehicle interior holding lip 26. Also, since the insertion force of the flange 7 is not changed largely even when the thickness of the flange 7 is changed, the flange 7 is easily attached to the vehicle body opening part 6 over the whole part of the vehicle body opening part 6.

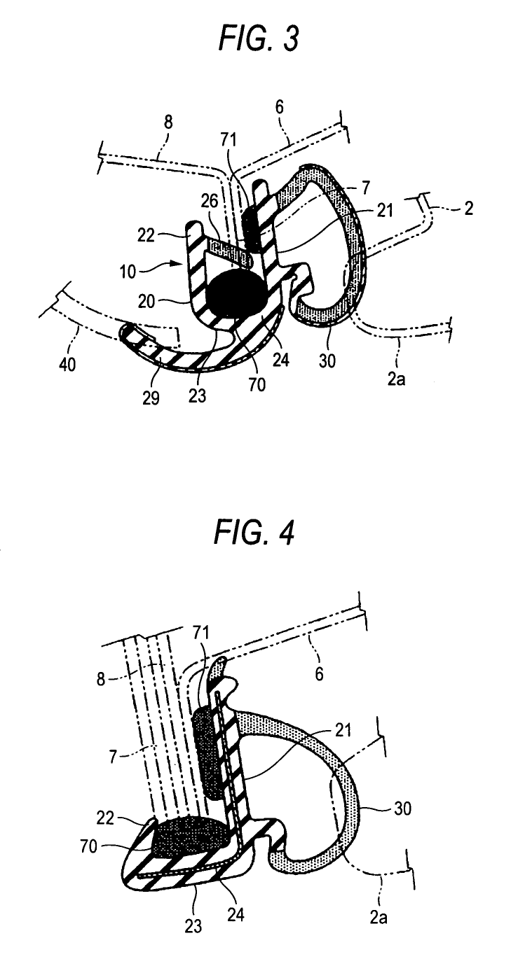

Hereinafter, a third embodiment will be described based on FIG. 3. The third embodiment is the same as the first embodiment except for omission of the vehicle exterior holding lips 25 that are disposed on the inner surface of the trim part 20, provision of a side wall sealant member 71 on the vehicle exterior side wall 21, and omission of the insert member 24 that is embedded into the trim part 20 in the first embodiment. Therefore, the different parts will be mainly described, and the description for the common parts is omitted.

In the third embodiment, the trim part 20 has a substantially U-shaped section, and the sealant member 70 is provided at the bottom 23 of the inner part of the trim part 20. The vehicle interior holding lip 26 is formed on the vehicle interior side wall 22. The vehicle exterior holding lips 25 are not formed on the inner surface of the vehicle exterior side wall 21, but the side wall sealant member 71 formed from an adhesive agent is provided on the inner surface of the vehicle exterior side wall 21. The side wall sealant member 71 is formed from the material used for forming the sealant member 70.

In a state where the side wall sealant member 71 and the side surface of the flange 7 are not in contact with each other, the tip of the flange 7 is inserted into the sealant member 70, and then the vehicle exterior side wall 21 is pressed against the side surface of the flange 7 to bring the side wall sealant member 71 and the side surface of the flange 7 into close contact with each other.

Therefore, it is possible to fix the flange 7 by the adhesion of the sealant member 70 to the tip of the flange 7 as well as by the adhesion of the side wall sealant member 71 to the vehicle exterior side surface of the flange 7, thereby stably holding the trim part 20. Accordingly, the position of the hollow sealing part 30 is stabilized, so that the hollow sealing part 30 reliably contacts the projection 2a of the door 2 to ensure the sealing property. In this case, the vehicle interior holding lip 26 contacts the vehicle interior side surface of the flange 7 to hold the flange 7.

It is possible to omit the vehicle interior holding lip 26 as is the case with the second embodiment. In the case of the omission, it is possible to hold the flange 7 by the adhesion forces of the sealant member 70 and the side wall sealant member 71.

Further, the insert member 24 is not embedded into the inner part of the vehicle exterior side wall 21, the vehicle interior side wall 22, and the bottom wall 23 forming the trim part 20. Therefore, it is possible to reduce the weight of the opening trim weather strip 10 as well as to enable easy production since it is unnecessary to mold the insert member 24 together with the polymer material in the extrusion molding (only the polymer material is to be molded). Since the sealant member 70 and the side wall sealant member 71 firmly adhere to the tip and the side surfaces of the flange 7 to hold the flange 7, the trim part 20 never comes off from the flange 7 without the insert member 24.

Hereinafter, a fourth embodiment will be described based on FIG. 4. The fourth embodiment is the same as the first embodiment except that the trim part 20 has a substantially J-shaped section, the vehicle interior side wall 22 is smaller, the vehicle exterior holding lips 25 are not provided, and the side wall sealant member 71 is provided on the vehicle exterior side wall 21. Therefore, the different parts will be mainly described, and the description for the common parts is omitted.

In the fourth embodiment, the trim part 20 has the substantially J-shaped section, the sealant member 70 provided at the part which is in close contact with the bottom wall 23 in the inner part, and the vehicle interior side wall 22 which is short and has a length for holding the sealant member 70. Further, the vehicle exterior holding lips 25 are not formed on the inner surface of the vehicle exterior side wall 21, while the side wall sealant member 71 formed from an adhesive agent is provided at the vehicle exterior side wall 21. The side wall sealant member 71 is made from an emulsion type adhesive agent wherein the acryl-based adhesive agent used for the sealant member 70 is used as a base material, and a content of a synthetic resin in water is 55%.

In a state where the flange 7 is oblique to the vehicle exterior side wall 21 and is not in contact with the vehicle exterior side wall 21, the tip of the flange 7 is inserted into the sealant member 70, and then the vehicle exterior sidewall 21 is rotated to be pressed against the side surface of the flange 7, thereby bringing the side wall sealant member 71 and the side surface of the flange 7 into close contact with each other.

Thus, since it is possible to fix the flange 7 by the adhesion of the sealant member 70 to the tip of the flange 7 and the adhesion of the side wall sealant 71 to the vehicle exterior side surface of the flange 7, it is possible to stably hold the trim part 20. Therefore, the position of the hollow sealing part 30 is stabilized, so that the hollow sealing part 30 reliably contacts the projection 2a of the door 2 to ensure the sealing property.

It is possible to reduce the weight of the opening trim weather strip 10 since the vehicle interior side wall 22 is made shorter, and, even when the thickness of the flange 7 is changed, it is possible to easily attach the flange 7 to the trim part 20 since the vehicle interior side wall 22 is short.

Also, since the insert member 24 is not embedded into parts other than the vehicle exterior side wall 21 and the bottom wall 23, it is possible to further reduce the weight of the opening trim weather strip 10.

Since the insert member 24 is embedded into the vehicle exterior side wall 21 and the bottom wall 23, the bottom wall 23 is not deformed when pressed by the tip of the flange 7, and it is possible to reliably insert the tip of the flange 7 into the inner part of the sealant member 70.

Hereinafter, a production method for the opening trim weather strip 10 will be described.

The opening trim weather strip 10 is molded by extrusion molding, and it is possible to integrally extrude the insert member 24, the solid rubber forming the trim part 20, and the sponge rubber forming the hollow sealing part 30 by using an extrusion molding machine in the case of embedding the metal or hard synthetic resin insert member 24 into the trim part 20.

In the molding of the opening trim weather strip 10, a synthetic rubber and a thermoplastic elastomer are used as molding materials. For example, an EPDM rubber or the like may be used as the synthetic rubber, and a polyolefin-based elastomer or the like may be used as the thermoplastic elastomer. As the sponge material, those obtained by foaming the EPDM rubber or the thermoplastic elastomer may be used.

In the case of the synthetic rubber, the synthetic rubber is transferred to a vulcanizing tank after the extrusion molding to be vulcanized and foamed by heating with a hot air, high frequency, or the like. In the case of the thermoplastic elastomer or the soft synthetic resin, the thermoplastic elastomer or the soft synthetic resin is foamed during the extrusion or after the extrusion by heating and then solidified by cooling.

In the case where the rubber is used, the trim part 20 has an angle section after the extrusion molding and the vulcanization, and the sealant member 70 is continuously inserted into the trim part 20 to be fixed to the bottom wall 23. After that, the trim part 20 is bent to achieve the substantially U-shaped section, and the insert member 24 of the trim part 20 is separated when so required. After that, the extrusion molded part is produced by cutting into a predetermined length.

The thus-produced opening trim weather strip 10 is attached to the flange 7 of a vehicle body opening rim of an automobile.

In the case of attaching the opening trim weather strip 10 to the flange 7, the trim part 20 is inserted into the flange 7 or a roll forming method wherein the trim part 20 is fixed in a state where an opening of the substantially U-shaped section is a little widened, and then the tip of the flange 7 is inserted into the sealant member 70 may be employed.

What is claimed is:

1. A weathers trip for sealing a gap between a vehicle body opening open/close member of an automobile and a vehicle body opening part of the automobile, comprising:
an attachment base to be attached to a flange provided on one of the vehicle body opening open/close member or the vehicle body opening part and
a sealing part provided integrally with the attachment base and brought into contact with the vehicle body opening open/close member or the vehicle body opening part to seal a gap between the vehicle body opening open/close member and the vehicle body opening part,
wherein the attachment base has a substantially U-shaped section or a substantially J-shaped section formed of a vehicle exterior side wall, a vehicle interior side wall, and a bottom wall and is provided with a sealant member made from an adhesive material and attached to an inner surface of the attachment base having the substantially U-shaped section or the substantially J-shaped section so that the attachment base is attached by inserting a tip of the flange into an inner part of the sealant member and by an adhesion force of the sealant member.

2. The automobile weather strip according to claim 1, wherein
a holding lip for holding the flange by contacting side surfaces of the flange is formed on inner surfaces of the vehicle exterior side wall and the vehicle interior side wall of the attachment base, and
an insert member is embedded into the attachment base, so that the attachment base is attached to the flange by the adhesion force of the sealant and a holding force of the holding lip.

3. The automobile weather strip according to claim 1, wherein
the inner surface of the attachment base is a flat surface;
the sealant member made from the adhesive material is attached at least to inner surfaces of the vehicle exterior side wall and. the bottom wall; and
the attachment base is attached to the flange by the adhesion force of the sealant member.

4. The automobile weather strip according to claim 1, wherein the attachment base is made from a polymer material such as a rubber and a resin without insert member.

5. The automobile weather strip according to claim 1, wherein the sealant member has a glass transition temperature of −10° C. or less, and the adhesion force of the sealant member is 15 to 40 N.

6. The automobile weather strip according to claim 1, wherein the vehicle body opening open/close member is a door, and the weather strip is an opening trim weather strip.

7. The automobile weather strip according to claim 5, wherein the sealant member is an acryl-based, silicone resin-based, or ethylene-vinyl acetate copolymer (EVA)-based synthetic resin.

8. The automobile weather strip according to claim 5, wherein the sealant member is a natural rubber-based, isoprene-rubber-based, or styrene-isoprene rubber-based rubber.

9. The automobile weather strip according to claim 5, wherein the sealant member is an emulsion type or a hot-melt type.

10. The automobile weather strip according to claim 7, wherein the sealant member is an emulsion of a copolymer of acrylonitrile and ester acrylate.

11. The automobile weather strip according to claim 1, wherein the sealant member is formed from an adhesive agent containing a synthetic resin-based or rubber-based base material having a glass transition temperature of −10° C. or less and an anti-rusting agent.

12. The automobile weather strip according to claim 11, wherein the anti-rusting agent is formed from at least one of a nitrite salt, an amine-based inorganic compound, and a phosphoric acid-based compound and contained in the adhesive agent in an amount of 1 to 5 wt %.

13. The automobile weather strip according to claim 12, wherein the base material of the sealant member is an acryl-based, silicone resin-based, or ethylene-vinyl acetate copolymer (EVA)-based synthetic resin.

14. The automobile weather strip according to claim 13, wherein: the base material of the sealant member is an emulsion of a copolymer of acrylonitrile and ester acrylate; and the anti-rusting agent is sodium nitrite.

15. The automobile weather strip according to claim 1, further comprising a sealant member to be used for a weather strip for sealing a gap between the vehicle body opening open/close member of an automobile and a vehicle body opening part of the automobile, wherein:
the weather strip comprises an attachment base having a substantially U-shaped section or a substantially J-shaped section to be attached to a flange provided on either one of the vehicle body opening open/close member or the vehicle body opening part and a sealing part provided integrally with the attachment base and brought into contact with the vehicle body opening open/close member or the vehicle body opening part to seal a gap between the vehicle body opening open/close member and the vehicle body opening part; and
the sealant member is formed from a synthetic resin-based or a rubber-based base material having a glass transition temperature of −10° C. or less, the base material being an adhesive agent in a foamed state.

16. The automobile weather strip according to claim 15, wherein the sealant member is foamed by physical foaming or chemical foaming.

17. The automobile weather strip according to claim 11, wherein the sealant member is in a foamed state.

18. The automobile weather strip according to claim 15, wherein: the base material of the sealant member is an emulsion of a copolymer of acrylonitrile and ester acrylate; and the foaming agent is dinitrosopentamethylenetetramine; and the foaming auxiliary agent is urea.

19. The automobile weather strip according to claim 14, wherein: the sealant member is an emulsion of a copolymer of acrylonitrile and ester acrylate; and the foaming agent is dinitrosopentamethylenetetramine; and the foaming auxiliary agent is urea.
